(19) United States
(12) Patent Application Publication
(10) Pub. No.: US 2009/0319338 A1
(43) Pub. Date: Dec. 24, 2009

(54) Method and system for virtual mentoring

(76) Inventors: Eric J. Parks, Rockford, IL (US); Mark Bankord, Rockford, IL (US); Kent Hoskins, Rockford, IL (US)

Correspondence Address: MCCRACKEN & FRANK LLP, 311 S. WACKER DRIVE, SUITE 2500, CHICAGO, IL, 60606, US

(21) Appl. No.: 12/456,648

(22) Filed: Jun. 19, 2009

Related U.S. Application Data
(60) Provisional application No. 61/132,819, filed on Jun. 23, 2008.

(51) Int. Cl. G06N 5/04; G06Q 30/00; G06Q 10/00

(52) U.S. Cl. 705/10; 706/52; 705/26

(57) ABSTRACT

A virtual mentoring system for assessing traits and improvement needs of a user is disclosed. The virtual mentoring system generates a personalized plan for the user that includes recommendations for reducing one or more inhibitors inversely correlated with improvement areas.

### CROSS REFERENCE TO RELATED APPLICATIONS

This application claims the benefit of provisional U.S. patent application Ser. No. 61/132,819, filed Jun. 23, 2009, which is incorporated by reference in its entirety herein.

### REFERENCE REGARDING FEDERALLY SPONSORED RESEARCH OR DEVELOPMENT

Not applicable

### SEQUENTIAL LISTING

Not applicable

### BACKGROUND

1. Field of the Disclosure

The present disclosure is directed generally to a method of and system for virtual mentoring including in one embodiment, an internet based software and computer implemented system to assess, analyze, and provide individualized recommendations to a user to identify a specific attribute or skill to improve and recommend particularized actions and resources that are designed to help the user improve the identified skill.

2. Description of the Background of the Disclosure

Historically, a mentor has generally been a person that is considered to be knowledgeable and wise regarding a certain life activity based on experience. A mentee, such as younger or less experienced person in the life activity, may interact with the mentor to seek guidance on how best to address the activity. Such interaction may prove to be difficult or impossible to achieve if the mentor and the mentee are not able to be paired together. The success of the mentor may be limited by an inability to adequately understand and assess the personality of the mentee. In some circumstances, the ability of the mentor to provide relevant advice may be limited based on the limited knowledge or experience of a certain life skill, or the mentor simply may not know of a particular resource that may be particularly helpful the mentee to realize certain life skill improvements. Even if the mentor does know of a particular resource for addressing certain life skill improvements, such resource may not be appropriate for the mentee because of the differences in personalities between the mentor and the mentee or because of where the mentee is in his or her life. In other circumstances, the mentee may be hesitant to approach the mentor with a specific question or problem because of embarrassment or simply being shy.

### SUMMARY

In one aspect of the invention, a computer program product for virtually mentoring a user, the computer program product embodied on a computer-readable medium and comprising code that, when executed, causes a computer to obtain individualized personal information about the user, identify a particular area of self-improvement of the user based on the personal information, generate a plan based on the personal information and the particular area of self-improvement, and suggest a resource selected to help the user improve the particular area of self-improvement.

In another aspect of the invention, a computer-implemented system for increasing a positive personal aspect of a user includes a database stored in a digital computer memory, the database including information regarding one or more resources that may be used to help a user improve positive personal aspects, a user assessment tool implemented on a computer that obtains information about the user including information about one negative personal trait associated with the user, and a plan generation tool implemented on the computer for generating a recommendation to reduce the negative personal trait. The recommendation includes a resource from the database to assist the user to implement the specific action.

In a further aspect of the invention, a method of identifying and improving a positive trait of a user includes the steps of identifying a number of positive traits that may be improved, for each positive trait, identifying a negative trait that is inversely correlated to the positive trait, and using a computer program product. The computer program product is embodied on a computer-readable medium and comprising code that, when executed, causes a computer to obtain information about personal characteristics of the user, assess what personal characteristics of the user correspond with one of the identified negative traits, select the identified positive trait to improve that is inversely correlated to the one identified negative trait, and recommend based on the selected positive trait to improve, a plan to the user designed to reduce the negative trait inversely correlated therewith, thereby improving the positive trait

In yet another aspect of the invention a system for virtually mentoring a user includes at least one electronic computer and a computer readable medium having stored thereon computer-executable code for controlling the electronic computer. The computer executable-code includes a first routine that obtains individualized personal information about the user, a second routine that identifies a particular area of self-improvement of the user based on the personal information, a third routine that generates a plan based on the personal information and the particular area of self-improvement, and a fourth routine that selects a resource in accordance with the plan to help the user improve the particular area of self-improvement.

In yet a further aspect of the invention, a computer program product for selecting a resource to help a first user modify a trait thereof from a plurality of resources, the computer program product embodied on a computer-readable medium an comprising code that, when executed, causes a computer to assess the first user to develop a first user profile and to identify the trait to be modified, select a second user from a plurality of users, wherein the second user has a second user profile associated therewith and the first user profile and second user profile are similar, obtain information from the second user regarding the effectiveness of one of the plurality resources in modifying the trait, and recommend to the first user the one of the plurality resources in accordance with the information obtained from the second user.

In still another aspect of the invention, a system for selecting a resource to help a first user modify a trait thereof from a plurality of resources includes an assessment tool that assess a user to develop a first user profile, a selection tool that selects a second user from a plurality of users, wherein the second user has a second user profile associated therewith and the first user profile and second user profile are similar, a feedback tool that obtains information from the second user regarding the effectiveness of one of the plurality resources in modifying the trait, and a recommendation generator that suggests to the first user the one of the plurality resources in accordance with the information obtained from the second user.

In a still further aspect of the invention, a computer program product for selecting a resource to increase the religious maturity of a user, the computer program product embodied on a computer-readable medium and comprising code that, when executed, causes a computer to assess the religious beliefs of the user, assess the religious practices of the user, identify an area of improvement in the users life, develop a metric from the assessment of the religious beliefs, and recommend a resource to the user to address the area of improvement that is selected in accordance with the metric and the religious maturity of the user, wherein the religious maturity is correlated with the religious practices and beliefs of the user.

In an additional aspect of the invention, a system of selecting a resource to increase the religious maturity of a user includes an assessment tool on a computer that assesses the religious beliefs of the user and the religious practices of the user, a growth finder tool on the computer that identifies an area of improvement in the users life, an analysis tool on the computer that develops a metric from the assessment of the religious beliefs, and a recommendation engine on the computer for selecting a resource for the user to address the area of improvement in accordance with the metric and the religious maturity of the user, wherein the religious maturity is correlated with the religious practices and beliefs of the user.

Other aspects and advantages of the present disclosure will become apparent upon consideration of the following detailed description.

### BRIEF DESCRIPTION OF THE DRAWINGS

FIG. 1 shows an embodiment of a virtual mentoring system;

FIGS. 2A-2E are examples of screenshots of interfaces provided by the system for gathering information about a user;

FIG. 3 is a flowchart of programming that may be executing by the virtual mentoring system shown in FIG. 1 for developing a personalized plan;

FIG. 4 is a flowchart of a growth trait analysis tool that may be used by the virtual mentoring system shown in FIG. 1;

FIG. 5 is a flowchart of programming executed by the virtual mentoring system of FIG. 1 for generating a plan;

FIG. 6 depicts a decision tree structure that may be used to generate the plan by the virtual mentoring system of FIG. 1;

FIG. 7 depicts a decision tree that may be used by the virtual mentoring system of FIG. 1 when configured to generate a plan for spiritual growth;

FIG. 8 shows a screenshot of an interface provided by the virtual mentoring system to gather feedback information from the user;

FIG. 9 is a flowchart of how feedback provided by the user may be used to modify the virtual mentoring system of FIG. 1; and

FIG. 10 shows a flowchart of programming that may be executed by the virtual mentoring system to modify decision trees thereof.

### DETAILED DESCRIPTION

In one aspect of the disclosure, a computerized system for virtually mentoring a user includes means for obtaining individualized personal information about the user; means for assessing particular traits of the user based on the personal information; means for generating a plan based on the traits of the user that identifies a particular area of self-improvement; and means for suggesting a resource selected to help the user improve the particular area of self-improvement. The means for obtaining may include means for obtaining demographics information, personality information, learning style information, beliefs information, and manifestations of the beliefs information regarding the user. The means for assessing may include means for identifying a belief score from the beliefs information and means for identifying a negative personal trait to be addressed. The means for generating a plan may include means for identifying the area of self-improvement that is responsive to the belief score and the negative personal trait and further is responsive to the personal information. The means for suggesting may include means for delivering the resource to the user. The means for delivering may include means for obtaining payment for the resource from the user. The computerized system may further include means for obtaining feedback from the user regarding effectiveness of the resource and/or means for tracking change in the particular area of self-improvement of the user. The means for obtaining individualized personal information may include means for obtaining a response from a user. The means for obtaining the response may include a display of a slider on an axis extending between two responses, wherein the displayed size of each response changes proportionally to the distance between the slider and the respective response. The means for obtaining the response may include a display of a slider inside a shape delineated by two axes, wherein each axis is associated with an idea and the ideas are inter-related.

In another aspect of the disclosure, a method of selecting a resource that is designed to help a user improve a selected area of personal self-improvement from a plurality of resources designed to help the user improve a plurality of areas of personal self-improvement includes the steps of assessing a control input user to identify a particular trait regarding that control input user; correlating the trait with a selected one of the areas of personal self-improvement; having the control input user provide information regarding the effectiveness of one of the plurality resources in addressing the selected area of personal self-improvement; and selecting the resource based on the information provided by the control input user.

In a further aspect of the disclosure, a method of identifying and improving a positive trait of a user includes the steps of identifying a number of positive traits that may be improved; for each positive trait, identifying a negative trait that is inversely correlated to the positive trait; obtaining information about personal characteristics of the user; assessing what personal characteristics of the user correspond with negative traits; selecting one of the positive traits to improve based on the negative traits; and recommending a plan to the user designed to reduce the negative trait, thereby improving the positive trait.

In a still further aspect of the disclosure, a computerized virtual mentor for increasing a positive personal aspect of a user includes a database including information regarding one or more resources that are identified to help a user improve one or more personal traits, a user assessment tool, wherein the user assessment tool includes a self-assessment tool for obtaining personal information about at least one of the user's personal traits, and a plan generation tool for generating a suggestion of a specific action for the user to undertake in order to reduce a negative personal trait and for identifying a recommended resource from the database designed to assist the user to implement the specific action. The negative personal trait may be identified from the personal information and may be inversely correlated with the positive personal aspect. The computerized virtual mentor may further include a fulfillment tool for causing the recommended resource to be made available to the user. The resource may include a physical item and the fulfillment tool may cause the recommended resource to be delivered directly to the user. The recommended resource may include an activity and the fulfillment tool may provide the user with access to the activity, and/or the recommended resource may include content that is downloadable from a connected digital source and the fulfillment tool may provide the user with the ability to download the content from the digital source. The computerized virtual mentor may include a user feedback system operatively connected with the database and the user assessment tool for allowing the user to provide information to the database regarding effectiveness of the specific action in reducing the negative personal trait. The user feedback system may allow the user to provide information to the database regarding effectiveness of the recommended resource in reducing the negative personal trait. The computerized virtual mentor may further include a group leader tool that allows a leader of a group of users to obtain information regarding at least one of the personal trait, the suggestion, the resource, and user feedback for users in the group of users. The group leader tool may allow the leader to input resources to the database for inclusion as recommended resources for the users of the group.

In yet another aspect of the disclosure, a computer implemented system for virtually mentoring a user includes an assessment tool for obtaining personal information about the user,

an assessment analyzer for discerning traits of the user based on the personal information, a growth analysis tool for determining a particular area of improvement for the user in accordance with the traits of the user, and a plan generator for providing the user with a selected resource selected from a plurality of resources, wherein the selected resource is selected in accordance with the personal information, the traits, and the particular area of improvement to help the user improve the particular area of improvement. The particular area of improvement in one embodiment is inversely correlated with an inhibitor, and the resource is selected in accordance with parameters designed to reduce the inhibitor.

In an additional aspect of the disclosure, a method of selecting a resource to help a first user improve a trait thereof from a plurality of resources includes the steps of assessing the first user to develop a first user profile, selecting a second user from a plurality of users, wherein the second user has a second user profile associated therewith and the first user profile and second user profile are similar, obtaining information from the second user regarding the effectiveness of one of the plurality resources in addressing the selected area of personal self-improvement, and recommending the one of the plurality resources to the first user in accordance with the information obtained from the second user. The step of selecting may comprise a step of determining whether the first user profile and the second user profile are similar, and the step of determining may include the steps of associating a first node in a decision tree with the first user profile, associating a second node with the second user profile, and identifying the first user profile as similar to the second user profile if the first node is the same as the second node.

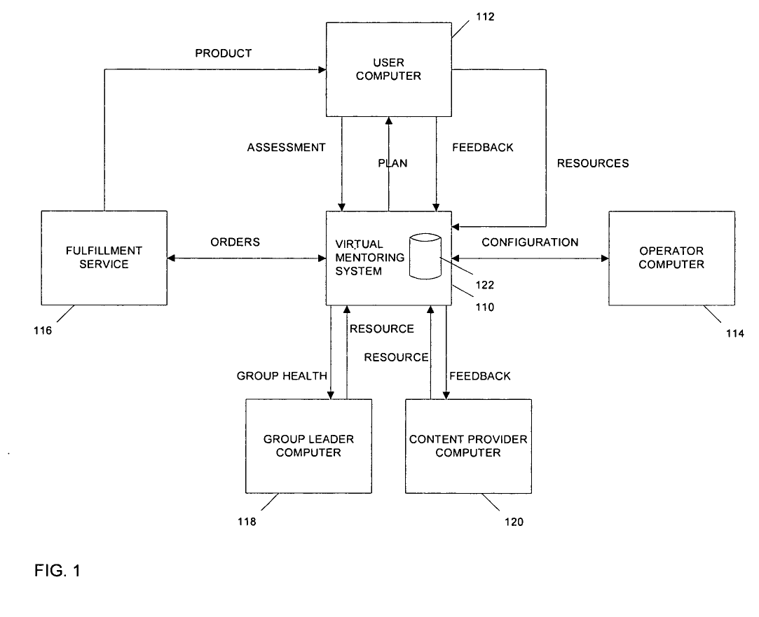

Turning now to the drawings, FIG. 1 shows an embodiment of a virtual mentoring system 110 that may be used for personal improvement and that includes interfaces for a user computer 112, an operator computer 114, a fulfillment service 116, a group leader computer 118, and a content provider computer 120 to interact with the system. In particular, the virtual mentoring system 110 provides an interface to allow the user to use the user computer 112 to provide responses to assessment and goal setting questions. The virtual mentoring system 110 analyzes such responses to develop a customized plan for the user, and presents the plan thereto via the user computer 112. As the user executes the plan, the user provides feedback using the user computer 112 to the virtual mentoring system 110 regarding the plan and the virtual mentoring system 110 uses such feedback in developing plans for subsequent users.

The virtual mentoring system 110 provides an interface for the operator computer 114 to allow the operator of the virtual mentoring system 110 to customize the assessments provided to the user for addressing different types of goals. Examples of goals that may be addressed by the virtual mentoring system 110 include spiritual growth, improving sales, learning new skills or behaviors, etc. The operator may use the operator computer 114 to provide configuration data to the system 110 to address such goals. In addition the operator may user the operator computer 114 to review feedback provided by the user to improve or modify the virtual mentoring system 110.

If the plan generated by the virtual mentoring system 110 for the user suggests a resource that may help the user execute the plan, the virtual mentoring system 110 may generate and transmit an order on behalf of the user 112 to the fulfillment service 116. In some embodiments, the fulfillment service 116 may be a subsystem of the virtual mentoring system 110 that manages orders and further transmits such orders (either paper orders or electronic orders) to retailers or resource providers. In other embodiments the fulfillment service 116 may be an entity separate from an entity that operates the virtual mentoring system 110. In still other embodiments, the fulfillment service 116 may provide resources directly to the user via a download (such as an electronic book, an electronic document, or an audio or video file) to the user computer 112.

The interface provided to the group leader computer 118 allows a group leader to obtain information regarding users who use the virtual mentoring system 110 and who are also members of the group. The group leader may be a church leader or pastor, a mentor, a trainer, a manager, etc. In addition, the virtual mentoring system 110 allows the group leader to use the group leader computer 118 to enter resources that may be included in plans generated for the users who are also group members.

The content provider computer 120 is provided an interface by the virtual mentoring system 110 that may be used by a content provider to enter information regarding resources that may be included in plans generated by the virtual mentoring system 110. For example, the content provider may use the content provider computer 114 to provide a link to a book, a notice of an event, an audio or video file, an electronic book, and the like to the virtual mentoring system 110. In some cases, the operator of virtual mentoring system 110 may need to approve each resource entered by the content provider. The operator of the virtual mentoring system 110 may use the operator computer 114 to review and/or approve such resources. In other cases, the content provider may be authorized by the system operator to enter resources into the virtual mentoring system 110 without the need for further approval by the system operator until such authorization expires or is revoked. The content provider may be a producer of original content (e.g., an artist or author) or a publisher of content produced by other individuals. In addition, the content provider may be affiliated with or employed by the operator of the virtual mentoring system or may be an independent entity that has been provided access to the virtual mentoring system 110.

The virtual mentoring system 110 includes a database 122 having data necessary to configure and/or operate the virtual mentoring system. The database 122 may also record information received from the user computer 112, the operator computer 114, the fulfillment service 116, the group leader computer 118, and/or the content provider computer 120. In some cases the operator of the virtual mentoring system 110 or other entity may interact directly with the virtual mentoring system (for example, using a display connected thereto) for adding or modifying information stored in the database 122.

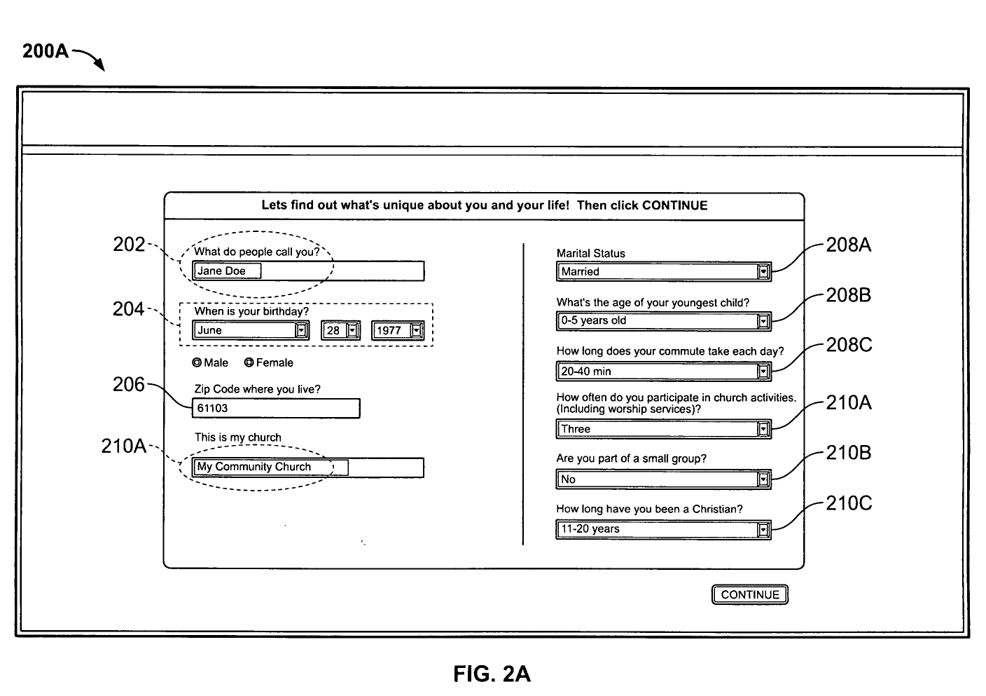

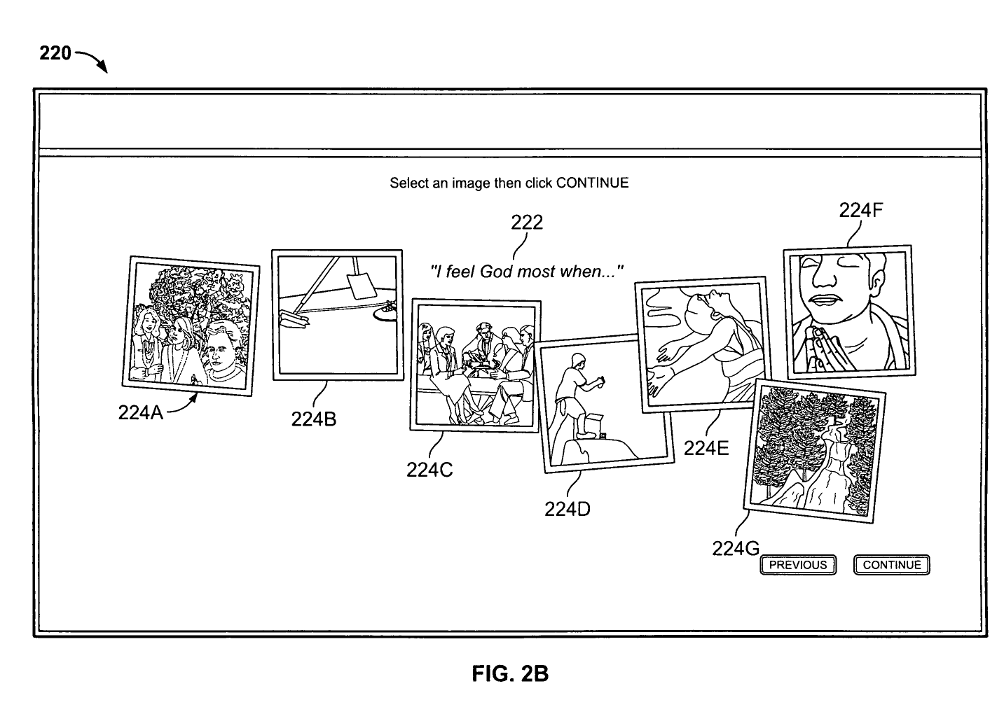

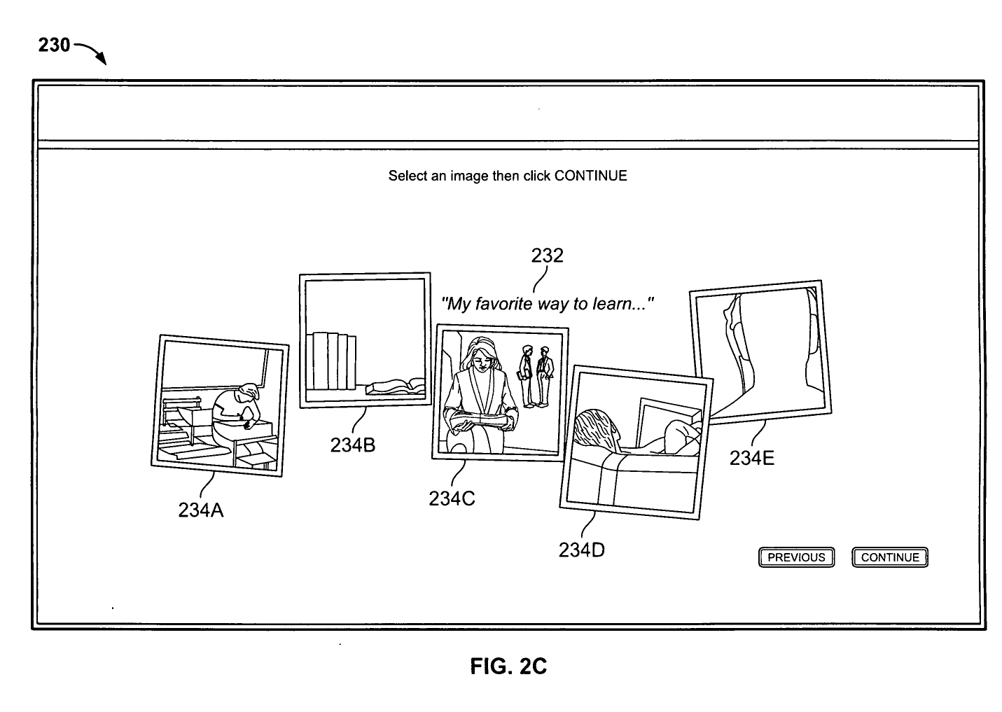

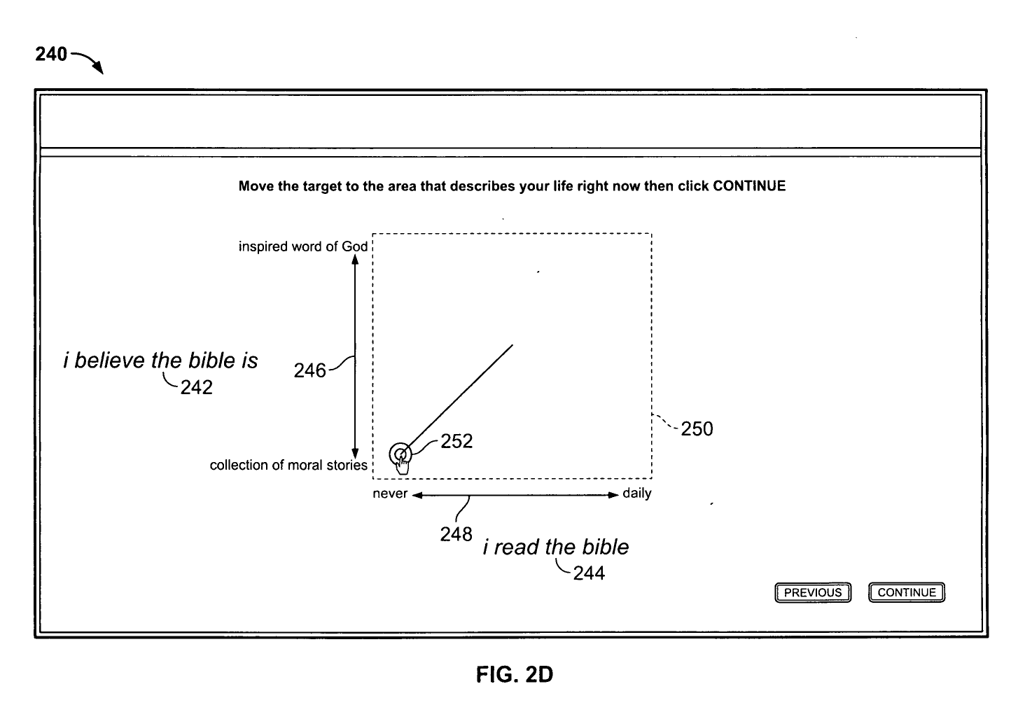

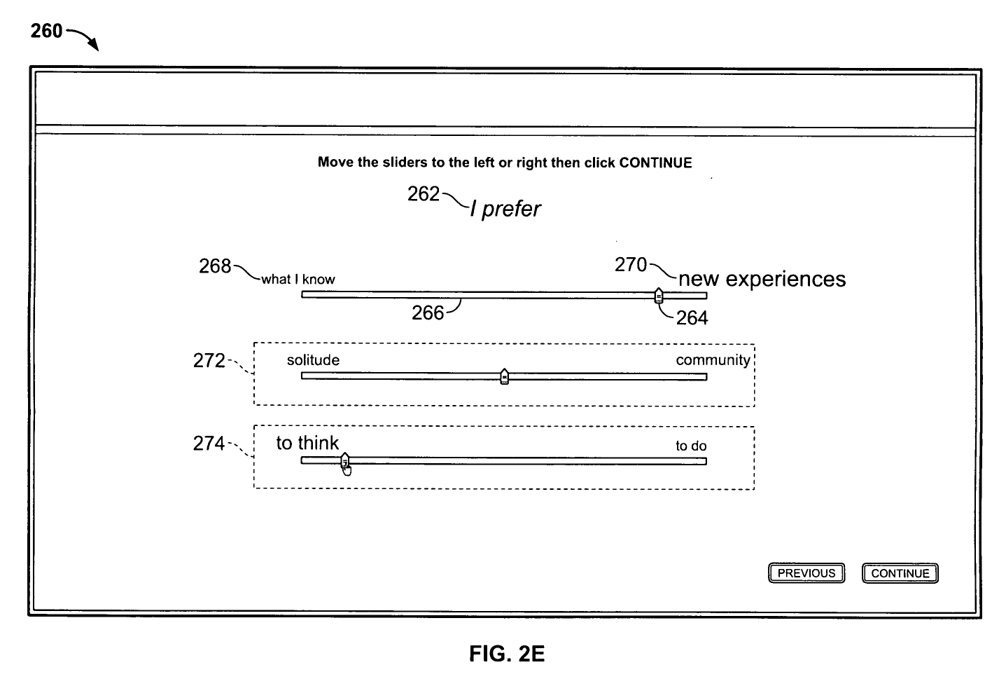

The virtual mentoring system 110 in one embodiment includes a web-based self-assessment tool that includes web pages that are presented to the user computer 112, wherein the web pages include assessment questions and receive responses therefrom. The self-assessment tool in one embodiment obtains responses that the user enters into the user computer 112 regarding traits, learning style, behavior style, beliefs, and attitudes thereof. FIGS. 2A-2E show examples of web pages that may be presented to the user. FIG. 2A shows a web page 200 that may be used to gather demographic and factual information about the user. For example, FIG. 2A includes a field 202 in which the user identifies himself or herself, a field 204 for entering his or her birthday (and thereby age), a field 206 to determine where the user lives, fields 208A and 208B to gather family status information about the user, and field 208C to gather lifestyle information about the user. The example shown in FIG. 2A is a web page that may be used as part of an application of the virtual mentoring system 110 that guides the user in the user's spiritual journey. Therefore, FIG. 2A includes fields 210A-210C to obtain information regarding the religious affiliations and practices of the user. If the virtual mentoring system 110 is used for other applications, for example, sales training, the web page used to gather demographic and factual information from the user may include fields that gather from the user information regarding employment history thereof or product lines sold thereby in the past and/or other information particularly relevant to assessing the user with regard to such a sales training application. Similarly, if the virtual mentoring system 110 is used to provide training, the web page used to gather demographic and factual information may include fields that gather information regarding the educational background of the user and/or other relevant information.

FIG. 2B shows a web page 220 that the virtual mentoring system 110 may present to, for example, a browser running on the user computer 112 as part of the assessment. The web page 220 presents to the user a first portion of an incomplete statement 222. The user may enter a response to complete the statement 222 by selecting using an input device connected to the user computer 112 one of the images 224A-224G. The user computer 112 transmits the selection made by the user to the virtual mentoring system 110, which may record the response provided by the user in the database 122. FIG. 2C shows another web page 230 that may be presented to the user by the virtual mentoring system 110. The web page 230 also presents an incomplete statement 232 and images 234A-234E that represent possible responses to the statement. The user selects the image 234A-234E that best represents his or her perspective in response or completion of the statement 232. The user computer 112 transmits the selection made by the user to virtual mentoring system 110.

In some cases, the images presented in web pages such as those illustrated in FIGS. 2B and 2C are correlated with a behavior, trait, or characteristic of the user. For example, each of the images 234A-234E shown in FIG. 2C may correspond to a particular learning style. Examples of such learning styles include classroom, conversation, reading, visual, and auditory.

Some embodiments of the virtual mentoring system 110 may be used to aid the operator in selecting the images that are presented on such web pages. The virtual mentoring system 110 is provided with candidate images that represent a particular trait (e.g., auditory learner). Such images are presented by the virtual mentoring system 110 to a sample group of people who, through other more extensive assessments, have been identified as exhibiting the trait. The virtual mentoring system 110 polls each member of the sample group to determine which image best represents the trait (e.g., how the member best learned). The image receiving the greatest number of votes from the members of the group is selected by the virtual mentoring system 110 as representing the trait in the assessment. The virtual mentoring system 110 may present images to the sample group of people and obtain responses therefrom using a computer connected thereto, for example the user computer 112, the operator computer 114, or the group leader computer 118. In other embodiments of the virtual mentoring system 110 or for other pages used by the virtual mentoring system, the operator may pre-select the images that are to be presented on the web pages and provide such images when configuring the virtual mentoring system 110.

FIG. 2D shows an example of another type of web page 240 that may be displayed on the user computer 112 by the virtual mentoring system 110 to obtain responses from the user. In particular, FIG. 2D presents two questions or statements to be completed 242 and 244 that are related to each other. The questions 242 and 244 are associated with axes 246 and 248, respectively. In this example, the question 242 prompts the user to gauge what the user believes, and the question 244 prompts the user to gauge how that belief is manifested, for example, by an action. The user provides an answer to these questions by positioning the pointer 232 on the display of the user computer 112 within the rectangle 250 delineated by the two axes 246 and 248. Some embodiments of the virtual mentoring system 110 record the coordinates of the position the pointer 252 with respect to the two axes 246 and 248 as a single combined answer to the two questions. Another embodiment of the virtual mentoring system 110 records the horizontal position of the pointer as measured along the axis 248 as a response to the question 244 and separately records the vertical coordinate as measured along the axis 246 as a response to the question 242. The ranges of the axes 244 and 246 may be identical or different. In one embodiment, the axes 244 and 246 have ranges that span from 0 to +4. In another embodiment, each axis 244 and 246 has a range from −5 to +5. Either of the axes 244 or 246 may have a range from any negative or non-negative number to another negative or non-negative number. The virtual mentoring system 110 may record a value for a coordinate of the position of the pointer 252 that is determined by rounding the coordinate to an integral value. Alternately, the virtual mentoring system 110 may record a value for the coordinate of the position of the pointer 252 that comprises both integral and fractional components.

FIG. 2E illustrates another web page 260 that may be displayed on the user computer 112 to obtain information from the user. The web page 260 comprises a question or an incomplete statement 262. The user uses an input device of the user computer 112 to position a slider 264 along an axis 266 disposed between two strings 268 and 270, wherein the two strings 268 and 270 represent two possible answers or completions to the statement 262, such as opposite ideas. The position of the slider 264 as measured along the axis 266 may provide an indication of an affinity to the ideas represented by the strings 268 and 270. In some embodiments, as the user adjusts the slider 264 along the axis 266, the size of each of the strings 268 and 270 associated with the endpoints of the axis 266 is adjusted proportionally. For example, the endpoints of the axis 266 are associated with the text strings “what I know” 268 and “new experiences” 270 as completions for the incomplete statement “I prefer . . . ” As the user moves the slider 264 from the endpoint associated with the string “what I know” 268 toward the string “new experiences” 270, the size of the string “what I know” 268 decreases and the size of the string “new experiences” 270 increases.

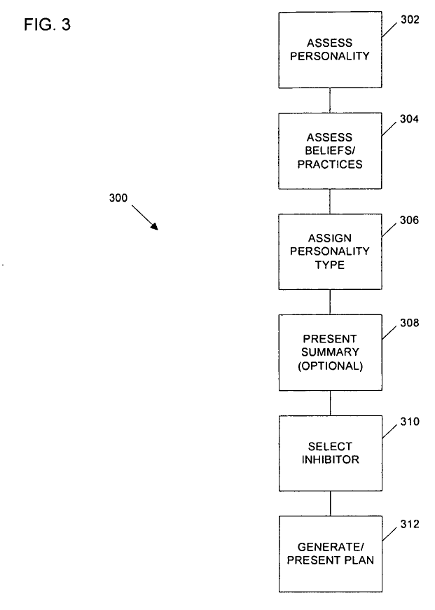

FIG. 3 shows a flowchart 300 of an embodiment of the virtual mentoring system 110 to develop a personalized plan for the user. A block 302 presents a series of web pages similar to those described above that contain questions directed to assessing the personality of the user. The demographics collected in FIG. 2A or the learning styles question illustrated in FIG. 2C are examples of such questions.

A block 304 presents to the user using the user computer 112 a series of web pages that include topic specific assessment questions. In one embodiment, such questions assess the beliefs practices of the user and are specific to the application for which the virtual mentoring system 110 is used. For example, the questions in FIG. 2D may be used to assess the spiritual maturity of the user and may be useful if the application for which the virtual mentoring system 110 is used is to provide spiritual growth. The virtual mentoring system 110 may be configured to present web pages by the block 304 to other questions that are appropriate to address other areas of development of the user, for example, sales force improvement.

A block 306 compares the responses provided by the user to the personality assessment questions with responses that are characteristic of individuals who have particular personality types. Based on the result of the comparison, the block 306 assigns a particular personality type to the user. In one embodiment, the particular personality type assigned is selected from a group of four personality types. However, the particular personality type may be selected from a group of fewer or more than four personality types. Examples of personality types include conductor-influencer, includer, friend, and worker.

A block 308 may optionally display a web page on the display of the user computer 112 a summary of the responses provided by the user to the assessment tool, the personality type with which the user has been associated, and/or characteristics of individuals who share a personality type identical to that of the user.

A block 310 performs a growth trait analysis, which assesses the aspects of the user, such as characteristics, traits, or behaviors that may need to be improved. Typically, the virtual mentoring system 110 may be configured to provide plans that are directed to improving specific positive characteristics by reducing correlated negative personal traits (inhibitors). In one embodiment, the virtual mentoring system 110 configured to provide spiritual growth is further configured to increase or improve ten positive traits of the user. Improving these ten traits allows the user to attain greater spiritual fulfillment. The ten positive traits are joy, peace, kindness, forgiveness, self-control, patience, goodness, thankfulness, faithfulness, and gentleness. Other positive traits may be selected for improvement for other applications of the virtual mentoring system 110. For example, a virtual mentoring system 110 configured improving traits of a sales force may consider presentability, listening skills, warmth, credibility, follow-through, etc., as positive traits to be improved or attained.

The virtual mentoring system 110 associates the ten positive traits that need to or may be improved with inhibitors that prevent maximizing such traits. In particular, one inhibitor (or negative behavior) is associated with dampening or reducing one or more of the ten positive traits. Table 1 shows an exemplary list of inhibitors and the positive traits dampened thereby.

TABLE 1

| Inhibitor | Positive Trait |
|---|---|
| A. Anxiety (Worry) | A. Joy, Peace |
| B. Bitterness (Revenge, enmity, | B. Joy, Kindness, Forgiveness |
| Strife) | |
| C. Contempt (Rivalries, Divisions, | C. Kindness, Forgiveness, Peace |
| Dissentions) | |
| D. Desires (Sexual Immorality, | D. Self-control, Patience, Goodness |
| Impurity, Sensuality) | |
| E. Envy (Jealousy) | E. Thankfulness, Kindness, Patience |
| F. Fury (Wrath, Anger) | F. Peace, Self-control, Forgiveness |
| G. Greed (Idolatry) | G. Thankfulness, Joy, Goodness |
| H. Hearsay (Slander, Obscene | H. Faithfulness, Gentleness |
| Talk) | |

Returning to FIG. 3, the block 310 selects the inhibitor that is to be addressed by the virtual mentoring system 110. In some embodiments the order of the block 310 and the block 308 may be exchanged and block 308 may precede the block 310. In such embodiments, the summary presented by the virtual mentoring system 110 to the user may incorporate information from the growth trait analysis. After the inhibitor has been selected, a block 312 generates a plan that may guide the user to reduce the inhibitor, and thereby improve the associated positive traits.

The virtual mentoring system 110 uses an additional assessment, hereinafter referred to as a growth analysis tool, to identify a particular inhibitor exhibited by the user that is to be reduced. The virtual mentoring system 110 is configured with typical inhibitors that are exhibited by individuals who have particular personality types. For example, with respect to the inhibitors shown in table 1, individuals who have a worker personality type may also tend to exhibit higher anxiety, bitterness, fury, and/or contempt. The virtual mentoring system 110 is configured such that these inhibitors are associated with the worker personality type as primary inhibitors. The virtual mentoring system 110 may also be configured to have at least additional secondary inhibitors and possibly tertiary inhibitors associated with certain personality types. For example, the worker personality type may be associated with secondary inhibitors envy and/or greed and tertiary inhibitors including hearsay and/or desires.

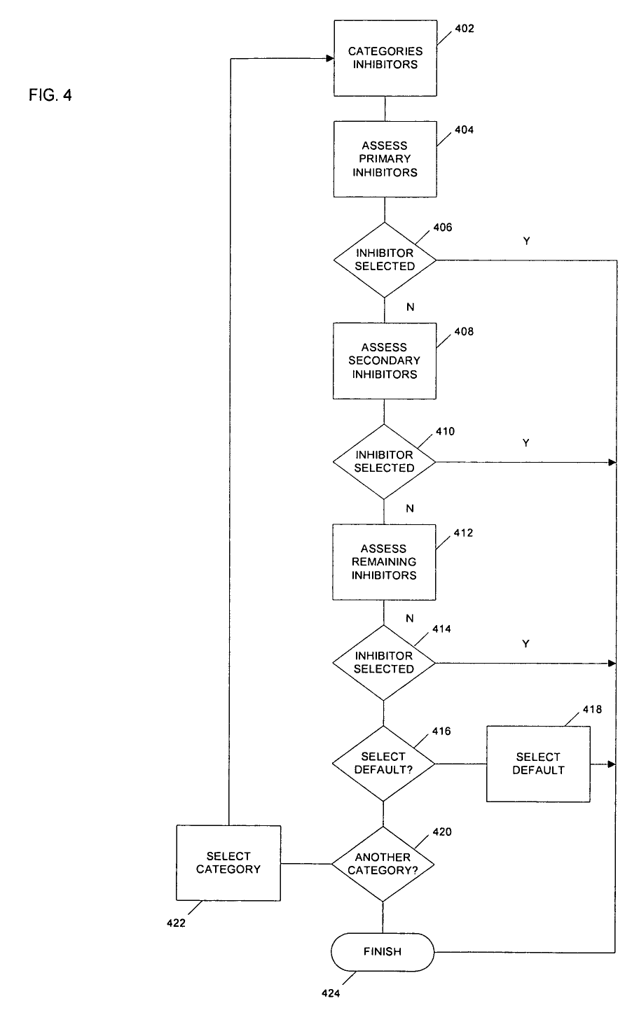

FIG. 4 illustrates a flow chart 400 of an embodiment of the growth analysis tool that may be used by the virtual mentoring system 110 to select an inhibitor (e.g., by the block 310 of FIG. 3). A block 402 categorizes the inhibitors into, for example, primary and secondary inhibitors in accordance with the personality type assigned to the user in response to the assess beliefs/practices by the block 304. A block 404 assesses the primary inhibitors associated with the user. In one embodiment, the block 404 presents to the user (using the user computer 112) a web page for each primary inhibitor associated with the personality type of the user. Such web page includes a question regarding the primary inhibitor, and several images associated with the primary inhibitor. The images depict varying levels of positive and negative behaviors associated with the primary inhibitor. The block 404 allows the user to select an image that most closely resembles how he or she feels or perceives himself or herself with respect to the primary inhibitor. For example, if anxiety is a primary inhibitor for the user, the block 404 may present a web page for anxiety that shows images depicting an alcoholic beverage, a person showing signs of distress, a person exercising, and/or a person apparently socially withdrawn. In some embodiments, the primary inhibitors for each personality type are sorted in accordance with the probability that an individual with a personality type identical to that of the user may exhibit a particular primary inhibitor. In such embodiments, the web pages associated with the primary inhibitors are presented in such sorted order and the most probable primary inhibitor may be shown first.

After presenting the images associated with the primary inhibitors, the block 404 analyzes the responses provided by the user using an input device connected to the user computer 112. If the user selected an image on the web page associated with one of the primary inhibitors that indicates a negative behavior, then the block 404 selects such primary inhibitor to address. If the user selected a negative image on web pages associated with more than one primary inhibitor, then the block 404 selects the primary inhibitor associated with the web page on which the user selected the most negative image. A block 406 determines if a primary inhibitor was selected by the block 404 and, if so, control passes to a block 424. Otherwise control proceeds to a block 408.

The block 408 displays a web page for each secondary inhibitor in a fashion similar to that described above in connection with the block 404 and determines whether to select one of the secondary inhibitors to address. As with the primary inhibitor selected by the block 404, the block 408 makes this determination based upon whether the user has selected an image that indicates a negative behavior. A block 410 determines whether an inhibitor was selected by the block 408 and, if so, control passes to the block 424. Otherwise, control proceeds to a block 412.

If the user does not select any negative images on the web pages associated with either the primary or secondary inhibitors, the block 412 presents to the user web pages associated with any remaining inhibitors. The block 412 determines which, if any, of the remaining inhibitors to select for addressing similar to the function of the blocks 404 and 408. A block 414 determines whether any of the remaining inhibitors was selected at the block 412 and if so control proceeds to the block 424. Otherwise control proceeds to a block 416.

For some applications the virtual mentoring system 110 may be configured to select a default inhibitor. If the virtual mentoring system 110 does not identify an inhibitor before reaching the block 416, then the block 416 determines whether the virtual mentoring system 110 has been preconfigured to select a default inhibitor, and if so, control passes to a block 418. The block 418 selects a pre-configured default inhibitor for the user. In some embodiments, the default inhibitor may be one of the primary inhibitors that has been statistically shown to be most prevalent in the particular personality type associated with the user. On the other hand, if the block 416 determines that a default inhibitor is not to be selected, control proceeds to a block 420 described further below.

For some applications, the virtual mentoring system 110 may attempt to select inhibitors from other categories of inhibitors that are still related to the application for which the virtual mentoring system 110 is configured. For example, if the virtual mentoring system 110 is configured for spiritual development and the virtual mentoring system is unable, based on the responses provided by the user, to select any of the inhibitors shown in table 1, the system may consider one or more additional categories of inhibitors that prevent the user from fully participating in a community or one or more categories of inhibitors that affect the relationship between the user and others. Referring once again to FIG. 4, the block 420 determines if the virtual mentoring system 110 has been configured to select another category of inhibitors and if so, control proceeds to the block 422. Otherwise control passes to the block 424. The block 422 selects another predetermined category of inhibitors to be assessed and proceeds to the block 402.

The block 424 records the inhibitor (if any) that has been selected by the preceding blocks. Thereafter, the virtual mentoring system 110 uses the selected inhibitor to develop a personalized plan for the user, for example, at the block 312 of FIG. 3.

In one embodiment of the virtual mentoring system 110, the personalized plan includes one or more objectives for each of four specific areas of the life of the user (time, mind, relationships, and experiences) and one or more corresponding resource(s) selected for the particular user to use to help meet such objectives. For example, the plan may recommend an objective of additional bible study and a corresponding resource may be information about a bible study group near where the user works. Similarly, the plan may include a recommendation for providing positive experiences for the user that includes the objective of giving back to the community and a corresponding resource may include volunteering at an event to clean up a city park. In addition, the plan may include a recommendation about increasing knowledge by the user that includes an objective of learning about how to think about prayer and a corresponding resource that may be a book to read. The plan may include daily, weekly, and/or monthly activities that the user may undertake. The resources that are included may be events, groups, literature, and/or products and may be either free or have a cost associated therewith. The plan is generated in accordance with the assessment of the personality, beliefs, and practices of the user so that the user may be more inclined to use the resources and thereby increase the effectiveness of the personal action plan.

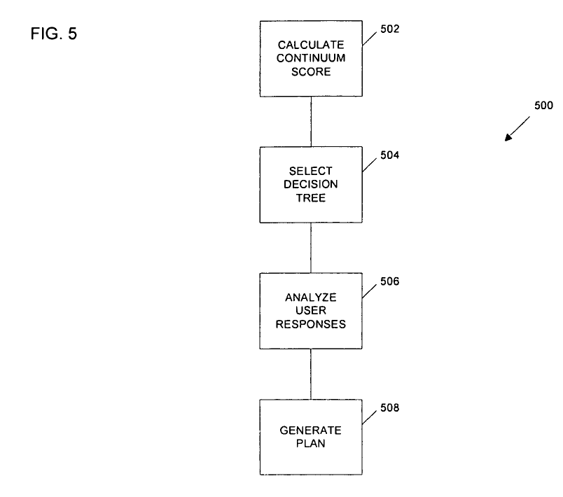

FIG. 5 shows a flowchart 500 of how one embodiment of the virtual mentoring system 110 generates a plan for the user (e.g., by the block 312 of FIG. 3). A block 502 calculates a continuum score associated with the user. The continuum score may be based on responses to the topic specific assessment questions of the assessment. In some embodiments, the continuum score is the average of numeric values (for example, the vertical coordinate) associated with responses to the belief questions presented by the web pages illustrated in FIG. 2D that assess the beliefs and practices of the user. In other embodiments, the continuum score may be a weighted or non-weighted average of numerical responses provided by the user to questions identified during the configuration of the virtual mentoring system 110 for a particular application. In still other embodiments, the continuum score may be a weighted combination of the personality type of the user and the responses provided by the user to particular questions. The continuum score may be calculated by different methods for the different applications for which the virtual mentoring system 110 is configured. In addition, the method used to calculate the belief score may be modified as the virtual mentoring system 110 operates (for example, as the operator of the virtual mentoring system gains additional information about the effectiveness of the virtual mentoring system 110). For some applications for which the virtual mentoring system 110 is used, a continuum score may not be calculated.

A block 504 selects one or more decision trees that are to be used to generate the plan. In one embodiment, one decision tree is selected for each life aspect (e.g., time, mind, experiences, or relationships) in accordance with the inhibitor(s) that is (are) to be addressed by the plan. In some embodiments, the virtual mentoring system 110 may be configured with multiple decision trees each associated with a particular life aspect and the selected inhibitor(s) and the block 504 selects one or more decision trees from among these in accordance with the continuum score. In other embodiments, the selected one or more decision trees may enable the virtual mentoring system 110 to produce a plan for all life aspects for which recommendations are to be made to reduce the selected inhibitor(s).

A block 506 uses the one or more decision trees selected by the block 504 to analyze responses provided by the user during the personality and topic specific assessments and to develop the recommendations that are included in the plan. A block 508 generates the plan in accordance with recommendations. The block 508 also stores the generated plan in the database 122 so that the user may recall the plan or track progress against the plan.

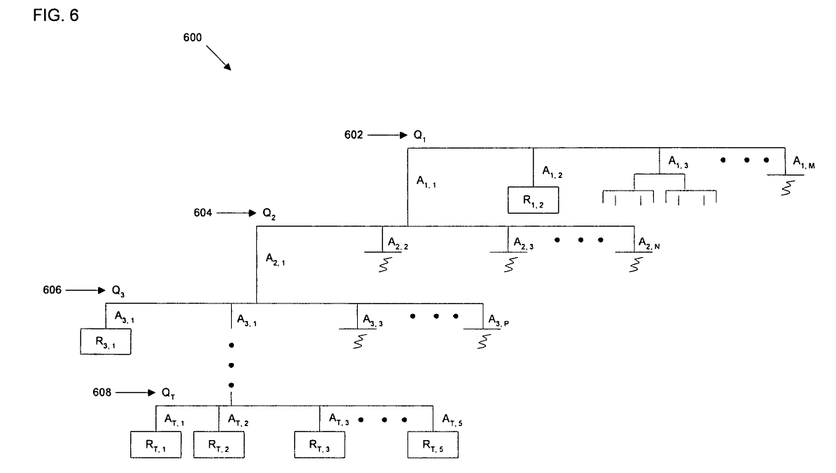

FIG. 6 depicts a generic decision tree 600 to illustrate how the decision tree may be used to generate the plan. The decision tree has multiple levels 602, 604, 606, and 608. As shown in FIG. 6, there may be additional levels between 606 and 608 or there may be fewer than four levels in the decision tree 600. Each level is associated with a particular question of the assessment. Level 602 is associated with a question represented by Q₁, which has possible responses represented by A_{1,1}, A_{1,2}, A_{1,3}, . . . , A_{1,M}. Similarly, level 604 is associated with a question represented by Q₂ that has possible responses A_{2,1}, A_{2,2}, A_{2,3}, . . . , A_{2,N}; level 606 is associated with a question Q₃ that has possible responses A_{3,1}, A_{3,2}, A_{3,3}, . . . , A_{3,P}; and level 608 is associated with a question Q_{T} that has possible responses A_{T,1}, A_{T,2}, A_{T,3}, . . . , A_{T,S}. If the response by the user to the question Q₁ is identical to the answer A₁, then the virtual mentoring system 110 considers the response by the user to question Q₂ at level 604. If the response by the user to question Q₁ is identical to the answer A_{1,2}, then the virtual mentoring system 110 selects the recommendation depicted by R_{1,2} and the virtual mentoring system 110 does not consider any further levels 604, 606, or 608 of the decision tree 600. Similarly, a response by the user to the question Q₁ that is identical to answer A_{1,3} leads the virtual mentoring system 110 to consider responses to yet another question (not depicted in FIG. 6), and so on. The virtual mentoring system 110 compares the response by the user to the question Q₁ with each of the possible responses A_{1,1} through A_{1,M} to either select another question or provide a particular recommendation. Because level 608 is the last level of the decision tree 600, any response by the user to the questions Q_{T} results in a recommendation. The specific recommendation selected by a response to the question Q_{T} is obtained by determining which one of the possible responses A_{T,1} through A_{T,S} the user's response matches. The response to the question Q_{T} is only considered for the user for which a recommendation was not determined at any of the preceding levels of the decision tree.

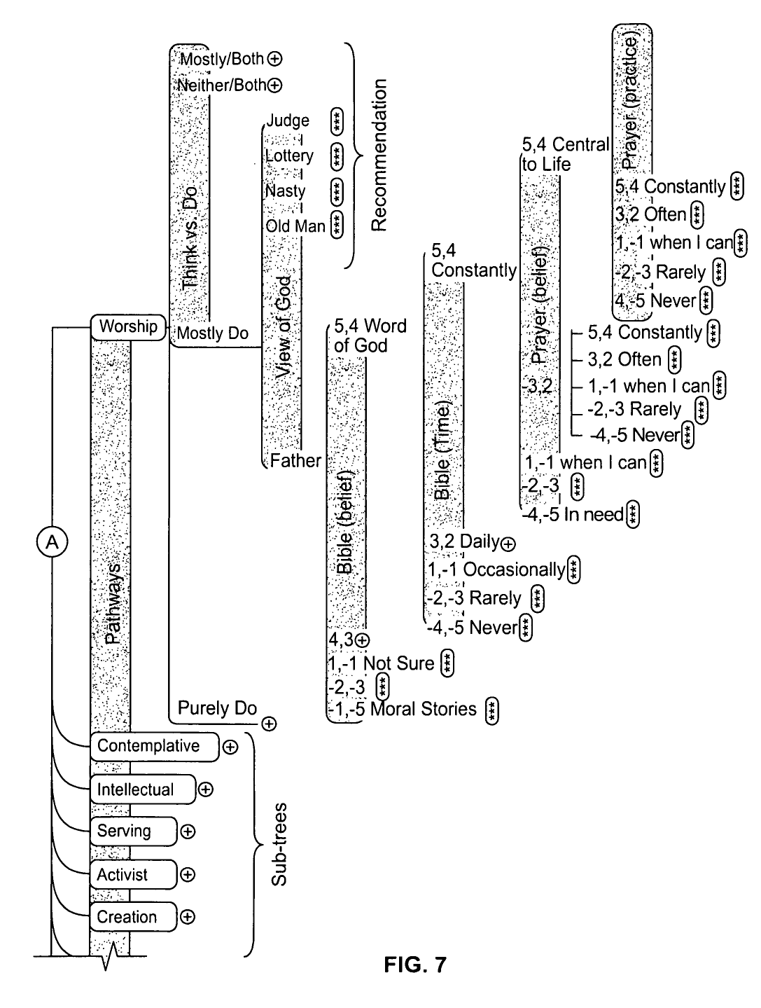

FIG. 7 shows an example of a decision tree that may be used by the virtual mentoring system 110 when configured for spiritual growth. For example, for one life aspect regarding how a person uses his or her time (the “My Time” life aspect), a decision tree has associated therewith seven hierarchically organized questions: “Pathways,” “Think vs. Do,” “View of God,” “Bible (belief),” “Bible (time),” “Prayer (belief),” and “Prayer (practice).” For the My Time life aspect, the top trait level, “Pathways,” has seven different pathway options corresponding to the seven possible answers to the “Pathways” question of the assessment tool. Each possible response to the “Pathways” question has a different sub-tree associated therewith. For example, a response associated with “worship” to the “Pathways” question, leads to the “Think vs. Do” questions. A “Mostly Do” response to the “Think vs. Do” question leads to the “View of God” question. One response to the “View of God” question leads to the “Bible (belief)” questions and the other possible responses lead to recommendations that may comprise the plan developed for the user. As described above, the virtual mentoring system 110 may not consider all levels of a decision tree. Instead, levels of the decision tree are considered until a recommendation node is reached. For example, in the decision tree shown in FIG. 7, if the response of the user regarding his or her view of God is “judge,” then the decision indicates a recommendation and, therefore, the virtual mentoring system 110 does not proceed to any further levels (e.g., “Bible (belief),” “Bible (time)”, etc.).

Because the user is expected to improve after following a given set of recommendations, the user can periodically re-evaluate his or her personal improvement in a particular area of life by re-taking the topic specific assessment and the questions from the growth trait analysis to obtain an updated evaluation and updated personal action plan. The process of re-evaluating may be repeated an unlimited number of times as long as the user feels a need for further improvement.

The recommendations selected through the analysis by the virtual mentoring system 110 using, for example, decision trees, are components of the personalized plan for the user 112. After the personalized plan has been developed, the virtual mentoring system 110 allows the user to obtain all or selected resources (books, information, audio sources, activity entrance passes, etc.) that are recommended by the personalized plan through the fulfillment service 116, such as a fulfillment server. The fulfillment server may incorporate an e-commerce engine for accepting orders from the virtual mentoring system 110, accepting payment information from the user (or from the virtual mentoring system 110 if previously provided thereto by the user), and generating orders to resource providers such as stores, publishers, wholesalers, internet content providers, activities providers, and other resources. In one embodiment, once the user has registered with the virtual mentoring system 110, such as by providing necessary address and payment information, the fulfillment service 116 may arrange for selected recommended resources to be automatically purchased and delivered to the user if the user approves or requests, such as by clicking a “buy” button, when reviewing the personalized plan generated by the virtual mentoring system 110.

The virtual mentoring system 110 in one embodiment may be configured to address widely divergent applications and uses by simply interchanging various assessment questions, growth trait analysis questions, and decision trees. In one embodiment, the virtual mentoring system 110 maintains such configuration information in the database 122 and adding one or more new database tables may configure the virtual mentoring system 110 for additional applications. For example, in one application the virtual mentoring system 110 may be adapted to help a religious person or community become closer to God, whereas in another application, the system 110 may be adapted to help a group of sales persons become more effective at selling product by simply replacing the questions of the topic specific assessment and the growth trait analysis tool of the religious application with different respective topic specific assessments and growth trait analysis tools directed to life aspects related specifically to improving sales effectiveness. One virtual mentoring system 110 may have a variety of topic specific assessment questions and growth trait analysis tools, and such a virtual mentoring system 110 may be used to provide different applications to different sets of users. Similarly, modules for many other individual or group-based areas of self-improvement may be developed using similar system architecture and supplying the particular questions, inversely correlated inhibitor/positive traits, decision tree nodes, and resources appropriate for the specific application.

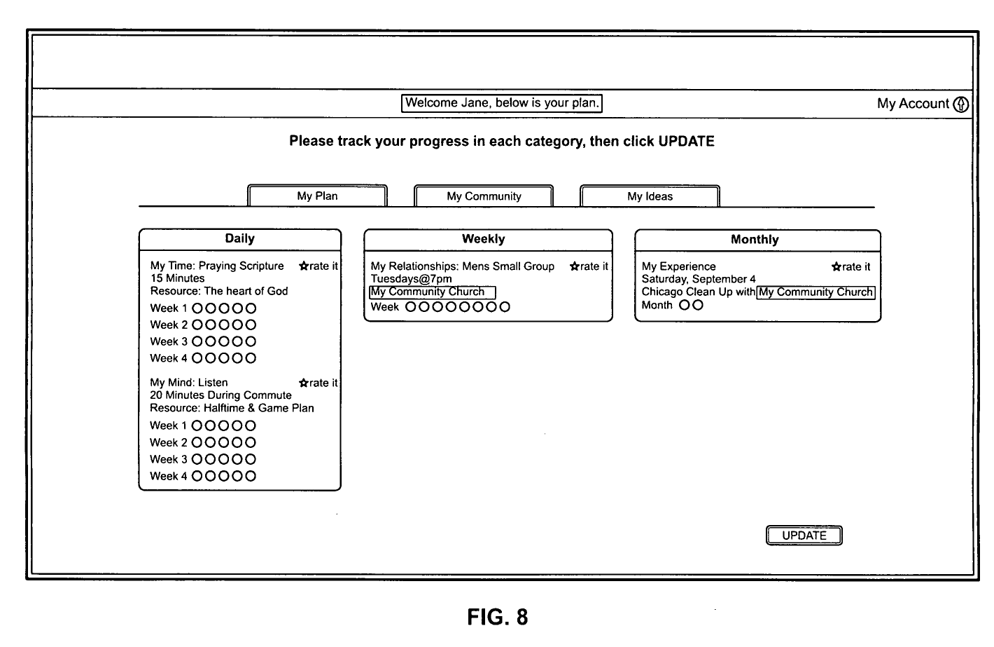

Some embodiments of the virtual mentoring system 110 allow the user to track the progress thereof in undertaking a recommended plan. FIG. 8 shows a web interface provided by the virtual mentoring system 110 so that the user may provide feedback to the virtual mentoring system to indicate how useful or appropriate a recommended objective and/or resource was for enabling changes the user expected. Such ratings provided by the user are recorded in the database 122 of the virtual mentoring system 110 and may be used to modify what resources are recommended in subsequent plans for subsequent users.

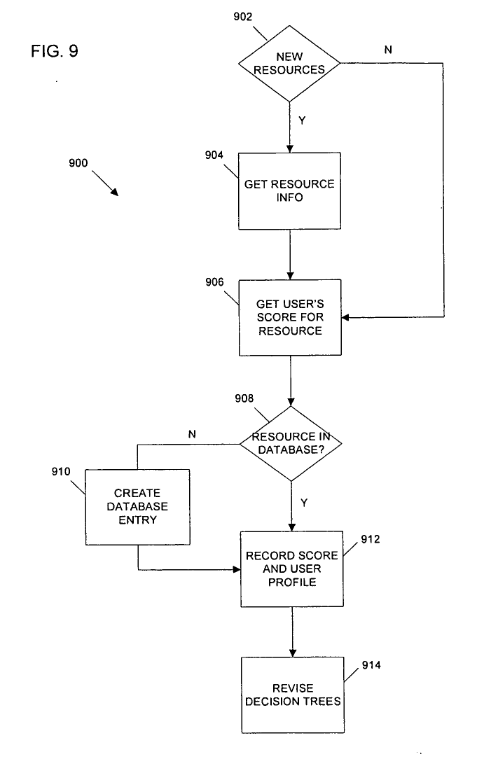

FIG. 9 shows a flowchart 900 of how feedback provided by the user may be incorporated into the virtual mentoring system 110. A block 902 determines whether the user is providing (using the user computer 112) feedback on a resource or recommending a new resource. If the user is recommending a new resource, then control passes to a block 904 that obtains information about the resource and thereafter proceeds to a block 906.

If the block 902 receives feedback from the user on the resource, control proceeds from the block 902 directly to the block 906.

The block 906 obtains an evaluation of the resource from the user, such as comments and/or a score for the resource. A block 908 determines if the resource is already in the database 122 of the virtual mentoring system 110. If the resource is not in the database 122 (therefore, the resource is new to the virtual mentoring system 110), then a block 910 creates an entry in the database 122 for the new resource; otherwise control proceeds to the block 912. The block 912 records the evaluation (including the score) provided by the user and also the profile of the user as determined by the assessments and growth trait finder tool.

A block 914 revises the recommendations that may be provided by the decision trees. In some embodiments, the block 914 revises a recommendation provided by the decision trees immediately upon receiving feedback from the user. In other embodiments, the block 914 revises the decision trees when the virtual mentoring system 110 is not busy or during prescheduled maintenance periods. In still other embodiments, the block 914 revises the decision trees after users have entered a predetermined number of recommendations. In yet other embodiments, the operator may use the operator computer 114 to review and edit the recommendations provided by the users before directing the block 914 to revise the decision trees.

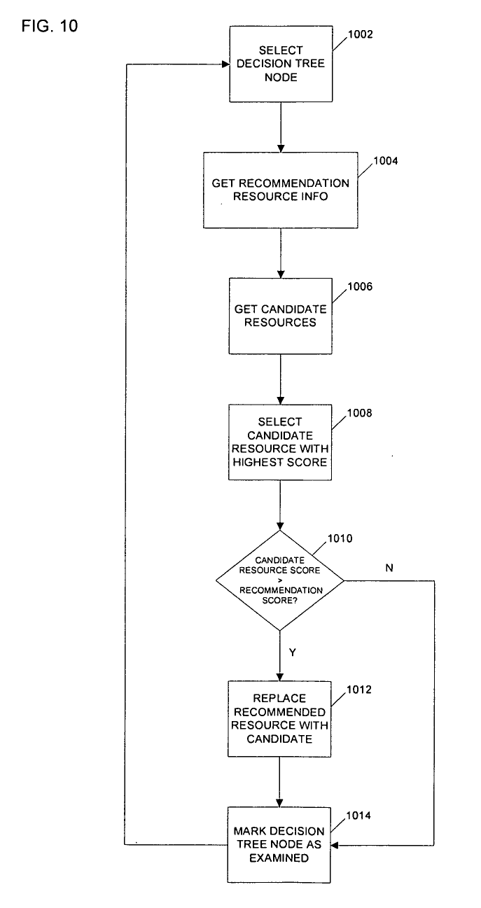

FIG. 10 shows a flowchart 1000 of how the virtual mentoring system 110 may modify the decision trees thereof in response to feedback provided by the user (e.g., by the block 914 of FIG. 9). A block 1002 selects a node of a decision tree that provides a recommendation (e.g., the node R_{1,2} of FIG. 6). A block 1004 obtains information about the resource that may be associated with the node. A block 1006 determines resources that are candidates for the selected node, for example, those resources recommended by one or more user(s) in the blocks 902-914. In one embodiment, the block 1006 selects as candidates those resources recommended by users who provided feedback indicating that the resource associated with the selected node be replaced by a different resource. In some embodiments resources provided by other users who have received a recommendation based on the selected node are selected as candidate resources. In other embodiments, those resources that have been recommended by similar users are selected as candidate resources. For example, two users may be considered similar if both users have received a recommendation from the same node of the decision tree. In such cases, recommendations for additional resources from similar users are selected as candidate resources that may recommended by the node of the decision tree shared thereby. In other cases, a similarity score may be calculated between two users. For example, a similarity score between two users may be a weighted or non-weighted sum of the number of personality traits the two users share. If the weighted sum exceeds a predetermined threshold (e.g., 75% of the number of personality traits considered), the two users are determined to be similar.

A block 1008 selects the candidate resource that has the highest score provided by a user. In some embodiments, the virtual mentoring system 110 may only select a candidate resource that has received recommendations from at least a predetermined number of users. When multiple users have recommended a resource, the virtual mentoring system 110 may use an average of the scores provided by the users to select the candidate resource. In some embodiments, the average may be a weighted average, wherein a weight is associated with the user that provided the score (e.g., a group leader may have a weight associated therewith that is higher than a member of the group).

A block 1010 compares the score of the candidate resource with the feedback score of the resource currently associated with the selected node. If the score of the candidate resource is higher, then control passes to a block 1012, otherwise the control proceeds to a block 1014. The block 1012 replaces the resource recommended by the selected node with the candidate resource and control proceeds to the block 1014.

The block 1014 records that the selected node has been examined and control proceeds to the block 1002. The blocks 1002 through 1014 are repeatedly executed until all of the nodes of all of the decision trees have been considered.

In some embodiments the virtual mentoring system 110 may have decision trees wherein some or all of the recommendation nodes do not have resources associated therewith. A group of users may add resources for such nodes as described above with respect to FIGS. 9 and 10. The virtual mentoring system 110 may have a configuration mode, wherein the virtual mentoring system 110 prompts users for recommendations to address particular inhibitors. Responses provided by users to such prompts may be used to populate the decision trees of the virtual mentoring system 110 for a particular application in the manner described above.

In some embodiments, in order to populate the resources that may be recommended, the virtual mentoring system 110 may allow each of a plurality of users to recommend a resource that the user has previously found useful or appropriate to undertake change in one of the life aspects addressed by the virtual mentoring system 110. For example, the user may enter information regarding a publication that is particularly useful for how to think about prayer that may be used as a recommendation in the mind aspect of the plan. The virtual mentoring system 110 may include such recommendations in the plans of other users whose assessment results are similar to those of the user providing the recommendation. Populating the virtual mentoring system 110 with resources in this manner is referred to herein as crowdsourcing and is used to populate a new implementation of the virtual mentoring system 110. In the event that the virtual mentoring system 110 is initially populated with only representative resources or no resources, crowdsourcing may also be used during early phases of operating the virtual mentoring system 110 to add resources recommended by users. Similarly, crowdsourcing may be used to localize the virtual mentoring system 110. In particular, when initially operated in a new group of users, such as a community or church, the virtual mentoring system 110 may have generic recommendations, which may not be tailored to have a uniquely local component relevant to the particular group, provided with the virtual mentoring system 110. Thereafter, members of the group may add localized recommendations, which may address issues uniquely relevant to the group to the system that may be used in addition to (or instead of) the generic recommendations.

In addition, through the interface provided by the virtual mentoring system 110 to a group leader computer 118, the group leader or mentor 118 of a group of users (e.g., a church pastor or community leader) may enter localized resources for inclusion into the plans generated for members of the group. In this manner, recommendations for specific activities and other resources may be localized such as for where a user lives or attends a church. Resources from local content providers (e.g., authors) may also be added to the virtual mentoring system 110 in this manner in one embodiment.

In another embodiment, the interface provided by the virtual mentoring system 110 to the content provider computer 120, publishers and other content providers may enter recommended resources in a similar manner as described above. Content providers (e.g., publishers, authors, and/or service providers) may enter recommendations of resources into the virtual mentoring system 110 to address particular needs for users, and the evaluations of such recommendations by the users may be used to assess the effectiveness of such resources.

In another aspect of the virtual mentoring system 110, the data collected regarding plans being pursued by a group of individual users or the concerns of individual users may be aggregated and provided to, for example, the leader that mentors the group. The leader may use such information as an aid in addressing concerns that are of importance to the group. Aggregated information may be provided over time to help the leader assess how members of the group are progressing or ongoing concerns that may need to be addressed, and thereby provide more effective leadership to the community as a whole and possibly to individual users.

The virtual mentoring system 110 may include a social networking component, wherein a group of users who are similar as described above and/or having similar aspects, such as following a similar plan, or having similar profiles, may participate in an online community. Such an online community may allow similar users to share ideas on how to pursue their individual plans, provide support to one another for completing plans, or collectively identify resources to recommend to the system or to one another.

Referring once again to FIG. 1, some or all of the interfaces of the virtual mentoring system may be provided by subsystems of the system 110. For example, the system 110 may include a user subsystem for providing an interface to the user computer 112, an operator subsystem for providing an interface with the operator computer 114, and the like. In some embodiments, such subsystems may all be implemented as one or more programs operating on a computer. In other embodiments, some of the subsystems may be implemented on separate computers communicating with one another. For example, the user subsystem that provides an interface to the user computer 112 may be operated on one computer and a publisher subsystem that provides an interface to the content provider computer 120 may be operated on another computer. In still other embodiments, one subsystem may be distributed among more than one computer. For example, the user subsystem may be distributed among several computers each operating a web server application and incoming user requests may be distributed among such computers using load-balancing techniques familiar in the art.

In some embodiments, the interfaces provided by the virtual mentoring system 110 are published web pages hosted on a computer server. Such web pages, for example, those that request input may use HTML, Flash, AJAX, or other publishing technologies used on the World Wide Web. In other embodiments, the interfaces may be provided using a stand-alone executed or interpreted computer programs implemented using languages such as C, C++, Java, Objective C, or Visual Basic.

For interfaces in which the virtual mentoring system 110 provides data to a computer server (e.g., an electronic reporting system used by the system operator or the publisher, an order receiving system using by a fulfillment service, etc.) the virtual mentoring system 110 may send electronic data files using file transfer protocols including FTP or HTTP. The virtual mentoring system 110 may also provide such data files to other systems by depositing such files into shared folders. For example, the interface to the fulfillment service may be implemented using an application program that generates electronic orders to the fulfillment service 116, for example using application-to-application data interchange protocols that comply with the Electronic Data Interchange (EDI) standard developed by ANSI or the SOAP standard developed by W3C.

In some embodiments, the virtual mentoring system 110 may be implemented on one or more personal computer(s) or server(s) using known or commonly available propriety or open source operating systems and software. If the virtual mentoring system 110 is implemented using more than one computer or server, such computers may be on a combination of a local area network and/or a wide area network. The wide area network may be a proprietary wide area network or a public network such as the Internet. Similarly, the user computer 112, the operator computer 114, the computers used by the fulfillment service 122, the group leader computer 118, and the content provider computer 120 may communicate with the virtual mentoring system 110 on any combination of a local area network or a wide area network (either proprietary or public) or other ways of transferring and/or communicating data.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use the disclosure and to teach the best mode of carrying out same.

1. A computer program product for virtually mentoring a user, the computer program product embodied on a computer-readable medium and comprising code that, when executed, causes a computer to perform the following:
obtain individualized personal information about the user;
identify a particular area of self-improvement of the user based on the personal information;
generate a plan based on the personal information and the particular area of self-improvement; and
suggest a resource selected to help the user improve the particular area of self-improvement.

2. The computer program product of claim 1, wherein causing the computer to obtain includes causing the computer to obtain information including at least one of demographics, personality, learning style, beliefs, and manifestations of the associated with the user.

3. The computer program product of claim 1, wherein causing the computer to identify includes causing the computer to develop a metric representing the beliefs information associated with the user.

4. The computer program product of claim 3, wherein causing the computer to generate a plan includes causing the computer to identify a recommendation in accordance with the metric, the area of self-improvement, and the personal information.

5. The computer program product of claim 1, wherein causing the computer to suggest includes causing the computer to initiate delivery of the resource to the user.

6. The computer program product of claim 5, wherein causing the computer to initiate delivery includes causing the computer to procure payment for the resource from the user.

7. The computer program product of claim 1, wherein the computer program product further causes the computer to obtain feedback from the user regarding effectiveness of the resource.

8. The computer program product of claim 1, wherein the computer program product causes the computer to track a change in the particular area of self-improvement of the user.

9. The computer program product of claim 1, wherein causing the computer to obtain individualized personal information includes causing the computer to obtain a response from a user.

10. The computer program product of claim 9, wherein causing the computer to obtain the response includes causing the computer to display a slider on an axis extending between two indicators, each indicator associated with a response, wherein the displayed size of each indicator changes proportionally to the distance between the slider and the respective indicator.

11. The computer program product of claim 9, wherein causing the computer to obtain the response includes causing the compute to display a slider inside a shape delineated by two axes, wherein a first axis is associated with a first idea, a second axis is associate with a second idea, and the first idea and the second idea are inter-related.

12. A computer-implemented system for increasing a positive personal aspect of a user comprising:
a database stored in a digital computer memory, the database including information regarding one or more resources that may be used to help a user improve positive personal aspects;
a user assessment tool implemented on a computer that obtains information about the user including information about one negative personal trait associated with the user; and
a plan generation tool implemented on the computer for generating a recommendation to reduce the negative personal trait, wherein the recommendation includes a resource from the database to assist the user to implement the specific action.

13. The computer-implemented system of claim 12, wherein the negative personal trait is identified from the personal information and is inversely related to the positive personal aspect.

14. The computer-implemented system of claim 12, wherein the computer-implemented system further includes a fulfillment tool to make the recommended resource available to the user.

15. The computer-implemented system of claim 14, wherein the resource includes a physical item and the fulfillment tool initiates delivery of the physical item to the user.

16. The computer-implemented system of claim 14, wherein the recommended resource includes an activity and the fulfillment tool provides the user with access to the activity.

17. The computer-implemented system of claim 14, wherein the recommended resource includes content downloadable electronically from a source and the fulfillment tool enables the user to download the content from the source.

18. The computer-implemented system of claim 12, further comprising a computer-based electronic user feedback system that receives information from the user regarding effectiveness of the resource in reducing the negative personal trait.

19. The computer-implemented system of claim 18, wherein the computer-based electronic user feedback system stores in the database a measure of effectiveness associated with the resource based on the information received from the user regarding effectiveness of the resource.

20. The computer-implemented system of claim 18, further comprising a computer-based group leader tool that allows a leader of a group of users to obtain information via a computer regarding at least one of the personal traits, the plan, the resources, and the user feedback for users that comprise the group of users.

21. The computer-implemented system of claim 20, wherein the computer-based group leader tool enables the leader to enter information into the database regarding resources that may comprise the plans generated for the users of the group.

22. A method of identifying and improving a positive trait of a user comprising the steps of:
identifying a number of positive traits of possible users that may be improved;
for each positive trait, identifying a negative trait that is inversely correlated to the positive trait;
using a computer program product, the computer program product embodied on a computer-readable medium and comprising code that, when executed, causes a computer to perform the following:
obtain information about personal characteristics of the user;
assess what personal characteristics of the user correspond with one of the identified negative traits;
select the identified positive trait to improve that is inversely correlated to the one identified negative trait; and
recommend based on the selected positive trait to improve, a plan to the user designed to reduce the negative trait inversely correlated therewith, thereby improving the positive trait.

23. The method of claim 22, wherein the negative trait is selected from a group of traits consisting of anxiety, bitterness, contempt, desires, envy, fury, greed, and hearsay.

24. The method of claim 22, wherein the performance of obtaining information about the personal characteristics includes the performance of obtaining information regarding the users personality traits, beliefs, and practices.

25. The method of claim 24, wherein the performance of assessing comprises causing the computer to perform so as to analyze the personality of the user.

26. The method of claim 24, wherein the performance of recommending a plan includes causing the computer to perform so as to analyze the beliefs of the user.

27. The method of claim 22, wherein the performance of recommending a plan comprises causing the computer to perform so as to identify a resource that may be used to reduce the negative trait of the user.

28. The method of claim 27, wherein the computer program product further causes the computer to perform so as to obtain feedback from the user regarding the effectiveness of the resource.

29. The method of claim 28, wherein the computer program product further causes the computer to perform so as to identify another user who is similar to the user.

30. The method of claim 29, wherein the performance of identifying another user comprises causing the computer to perform so as to select the other user if the other user has personal characteristics associated with the negative trait.

31. The method of claim 30, wherein the method comprises the step of forming a community that includes the user and the other user being interconnected electronically through an internet-based virtual community system.

32-70. (canceled)
